(19) United States
(12) Patent Application Publication
(10) Pub. No.: US 2006/0280842 A1
(43) Pub. Date: Dec. 14, 2006

(54) Modular food platter assembly and methods of use and assembly

(76) Inventor: Charles Moncavage, Nazareth, PA (US)

Correspondence Address: MONTE & MCGRAW, PC, 4092 SKIPPACK PIKE, P.O. BOX 650, SKIPPACK, PA, 19474, US

(21) Appl. No.: 11/451,550

(22) Filed: Jun. 12, 2006

Related U.S. Application Data
(60) Provisional application No. 60/690,068, filed on Jun. 13, 2005.

(51) Int. Cl. A23B 7/148

(52) U.S. Cl. 426/106

(57) ABSTRACT

A food platter assembly (100) including a base platter (110) sized to retain a plurality of containers disposed thereon, and the plurality of containers (130), wherein each of the plurality of containers contains a prepackaged food product contained therein. A method of providing the assembly and a method of assembling the assembly are also provided.

### CROSS-REFERENCE TO RELATED APPLICATION

This application claims priority from Provisional U.S. Patent Application Ser. No. 60/690,068 filed Jun. 13, 2005.

### FIELD OF THE INVENTION

The present invention relates to a modular food platter assembly that is used to selectively assemble a multi-food platter.

### BACKGROUND OF THE INVENTION

Party trays have become an increasingly popular way to present food for larger gatherings, such as parties. The trays typically consist of different types of finger vegetables, such as carrots, celery, broccoli, cauliflower, and cherry tomatoes, spread in an annular fashion on a round serving platter, with a container of dipping sauce centrally located on the platter. Other types of trays include fruit trays with cut up pieces of fruit, such as watermelon, honeydew melon, cantaloupe, strawberries, and blueberries, also spread in an annular fashion on a round serving platter, with a container of dipping sauce centrally located on the platter. Still other types of trays include meats and cheeses, typically cut into cubes, also spread in an annular fashion on a round serving platter, with a container of dipping sauce centrally located on the platter.

These trays are typically prepared in a professional environment, such as in a back room of a grocery store or in a meat preparation facility, giving the consumer little or no option in the exact types and proportions of the different types of foods being assembled for the platter. Such a presentation arrangement often provides platters that include food types having little or no appeal for certain gatherings. As a result, unwanted types of food sit on the platter, relatively untouched and wasted, while popular types of food are removed and eaten, leaving latecomers with only relatively distasteful food types remaining on the platter.

It would be beneficial to be able to provide a food platter system that enables a consumer to selectively determine particular foods for a platter in order to maximize enjoyment of those who will be partaking of the platter food. It would also be beneficial to be able to easily add additional foods to a platter during a party to replace popular foods that have been already eaten by guests.

### BRIEF SUMMARY OF THE INVENTION

Briefly, the present invention provides a food platter assembly. The assembly comprises a base platter sized to retain a plurality of containers disposed thereon and the plurality of containers, wherein each of the plurality of containers contains a prepackaged food product contained therein.

Also, the present invention provides a method of assembling a party tray assembly comprising providing a base platter; providing a selection from a plurality of containers, wherein a first subset of the plurality of containers contain different foods contained therein than a second subset of the plurality of containers; selecting at least one of the plurality of containers from the first subset and at least one of the plurality of containers from the second subset; and placing the at least two of the plurality of containers onto the base platter.

Further, the present invention provides a method of providing a party tray assembly comprising providing a base platter; and providing a selection from a plurality of containers, wherein a first subset of the plurality of containers contain different foods contained therein than a second subset of the plurality of containers, wherein each of the plurality of containers is sized to fit onto a portion of the base platter.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a food platter assembly according to the present invention;

FIG. 2 is a top plan view of a base platter of the food platter assembly of FIG. 1;

FIG. 3 is a top plan view of a food container of the food assembly of FIG. 1;

FIG. 4 is a side profile view of the container of FIG. 3;

FIG. 5 is a sectional view of the container of FIGS. 3 and 4, disposed on the base platter of FIG. 2;

FIG. 6 is a top plan view showing multiple embodiments of containers disposed on the base platter; and

FIG. 7 is a top plan view showing an alternative embodiment of containers to be used in the food platter assembly of the present invention.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

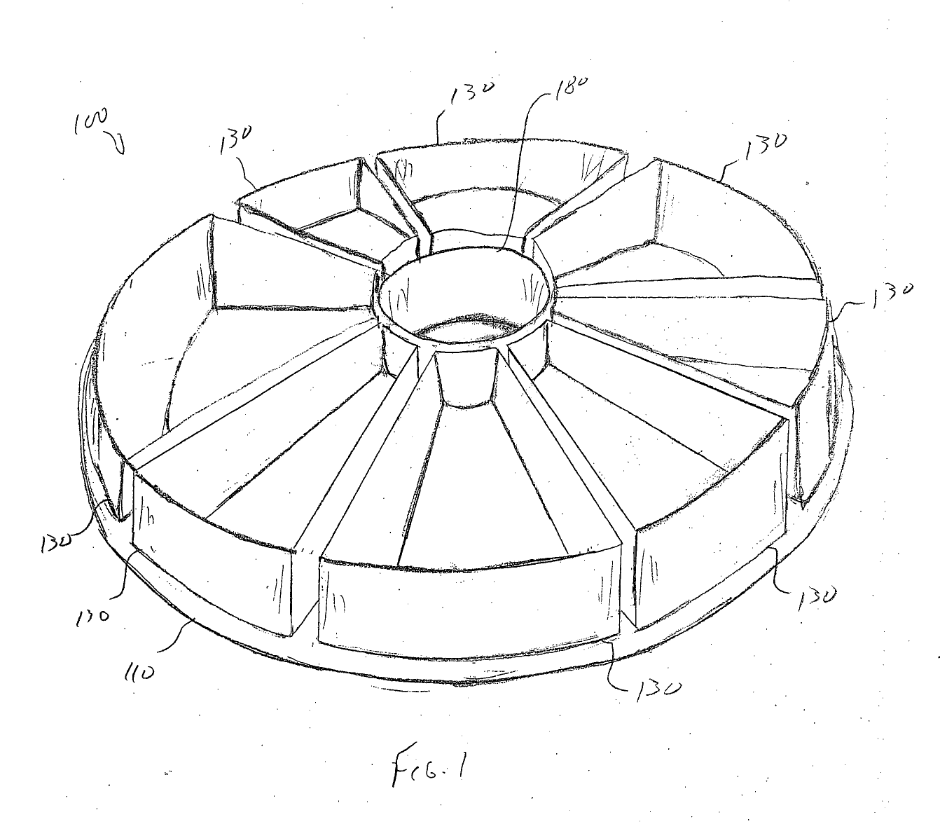

A preferred embodiment of a modular food platter assembly 100 according to a first preferred embodiment of the present invention is shown in FIG. 1. The assembly 100 includes a base platter 110 and a plurality of food containers 130 that are selectively disposable on the base platter 110. Preferably, the base platter 110 and the food containers 130 are each constructed from a polymer, such as polyethylene. Also preferably, although not necessarily, the containers 130 may be transparent to allow a user to easily see the food that is contained in a respective container 130.

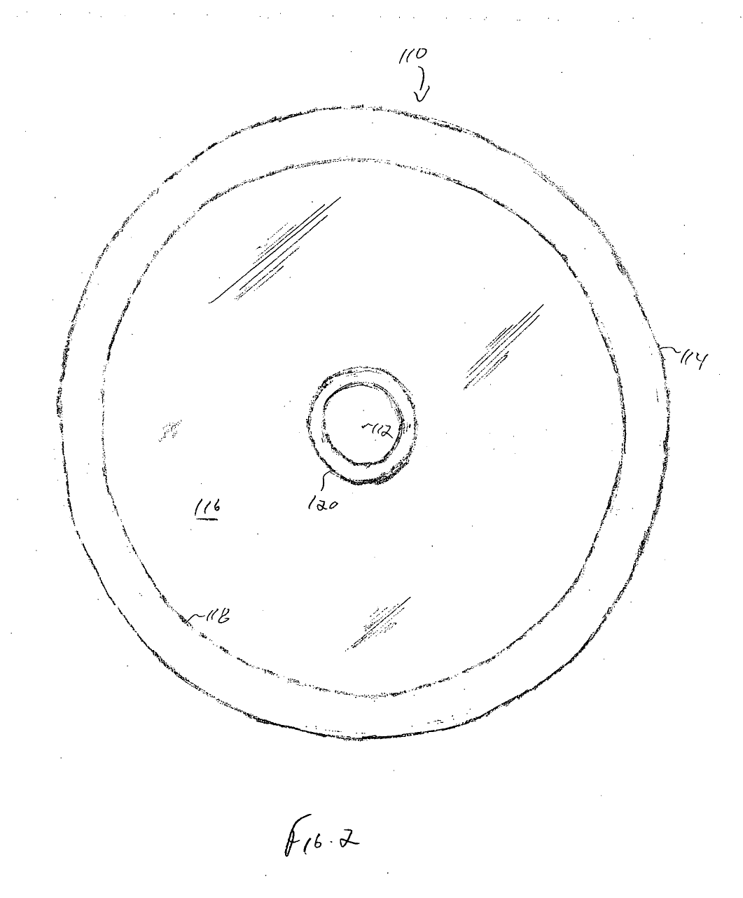

Referring to FIG. 2, the base platter 110 is preferably generally circular in shape, with a center 112 and an outer diameter 114. The base platter 110 also includes a top face 116, on which the containers 130 are disposed. The outer diameter 114 includes a convex ridge 118 that extends upward from the top face 116. The ridge 118 engages the containers 130 and restricts the containers 130 from sliding off the base platter 110.

Optionally, a second circular ridge 120 may extend from the top face 116 proximate to the center 112. The second circular ridge 120 is preferably convex and forms a bowl for receiving a circular container, such as for a dipping sauce.

A food container 130 for use with the base platter 110 is shown in FIGS. 3-5. The food container 130 is generally wedge-shaped, and preferably forms approximately one-eighth of a circle, so that eight containers 130 may be set side-by-side on the top face 116 of the base platter 110. However, those skilled in the art will recognize that the containers 130 may be more or less than one-eighth of a circle, so long as, preferably, a whole number of containers 130 are able to fit onto the base platter 110 without excess space between any adjacent containers 130.

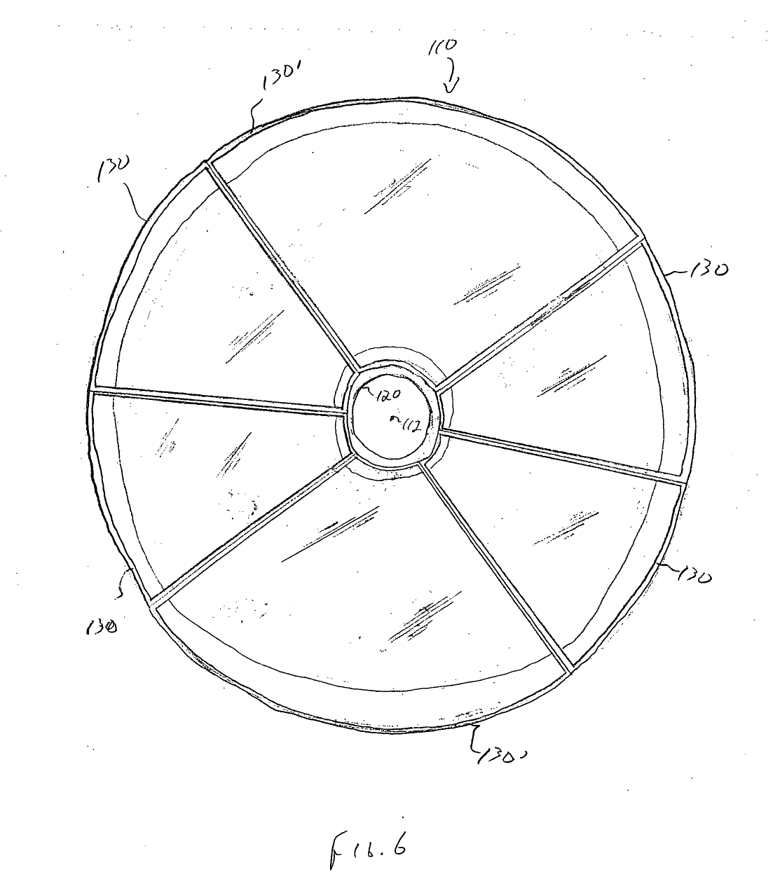

Also, while all of the containers 130 on the base platter 110 are preferably the same size, those skilled in the art will recognize that some containers 130′, such as is shown in FIG. 6 may be used with the containers 130. In this instance, each container 130′ is approximately twice the size of the container 130 so that, in the example shown, four containers 130 and two containers 130′ fill out the base platter 110.

Referring back to FIGS. 3-5, each container 130 includes a base 132 and a plurality of walls that extend upwardly from the base 132. A first wall 134 has a first end 136, a second end 138, and a first radiused portion 140 extending between the first end 134 and the second end 136. The first radiused portion 140 includes a center point 142 that generally coincides with the center 112 of the base platter 110 when the container 130 is placed on the top face 116 of the base platter 110. A second wall 144 extends from the first end 134 toward the center point 142 and a third wall 146 extends from the second end 136 toward the center point 142.

If a dipping container is omitted from the assembly 100, the second wall 144 and the third wall 146 may converge and meet at the center point 142. However, if the dipping container is used, the container 130 preferably includes a fourth wall 148 that joins the second wall 144 and the third wall 146. The fourth wall 148 preferably is radiused and includes the center point 142 as the starting point of the radius. Preferably, a lip 149 extends around the top perimeter of each of the walls 134, 144, 146, 148.

The container 130 includes a groove 150 that extends between the base 132 and the first wall 134. The groove 150 is sized and shaped to match the ridge 118 so that the ridge 118 restricts the container 130 from sliding off the base platter 110. If the base platter 110 includes the optional second circular ridge 120, then the container 130 will include a second groove 152 that is sized and shaped to match the second circular ridge 120.

Preferably each container 130 includes a lid 160 that is removable and replaceable onto the container 130. The lid 160 preferably snaps onto the top of the container 130 to securely retain the lid 160 onto the container 130. A preferred method of securing the lid 160 to the container 130 is shown in FIG. 5. The lid 160 snaps around the lip 149, as is well known in the art. The lid 160 is removed to access the food within the container 130, and replaced over the lip 149 to close the container 130, such as, to put the container 130 in a refrigerator after use.

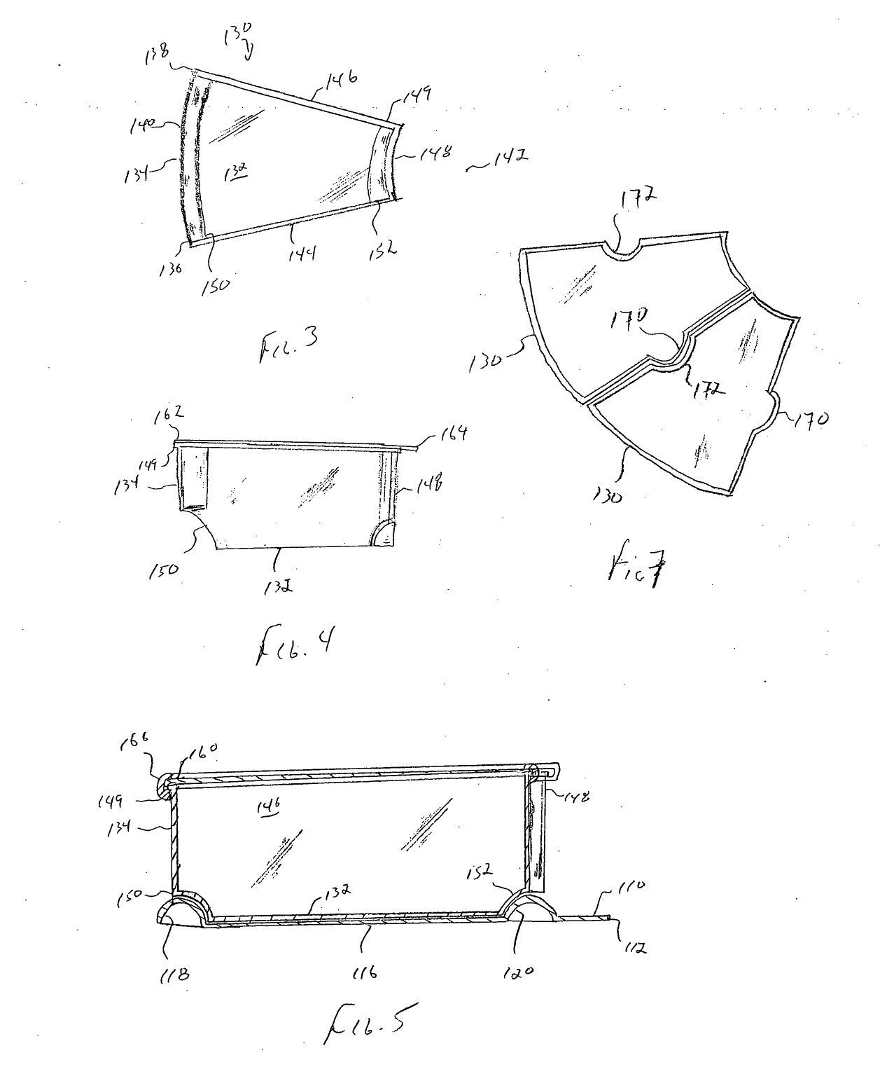

Also optionally, a flexible seal may be sealed around the container 130 to preserve the freshness of the food within the container 130. As shown in FIG. 4, the seal may be a seal 162 that is directly sealed over the lip 149, such as by adhesive or heat sealing. Preferably, the seal 162 includes a tang 164 that overhangs the lip 149 and allows a user to grip the seal 162 to peel the seal 162 away from the lip 149. Alternatively, the flexible seal may be a seal 166 that seals the lid 160 onto the lip 149, as is shown in FIG. 5.

Optionally, as shown in FIG. 7, each container 130 may include an interlocking member 170 that engages a mating receiver 172 in an adjacent container 130. While a specific interlocking member 170 and mating receiver are shown, those skilled in the art will recognize that other methods of interlocking a container 130 with an adjacent container 130 are within the scope of this disclosure.

The container 130 is used to contain prepackaged food for serving on the base platter 110. For example, each of the containers 130 that may be used with the base platter 110 may contain a different vegetable (carrot sticks, celery, broccoli, cauliflower, cherry tomatoes), fruit (watermelon, cantaloupe, honeydew melon, strawberry), deli food (cheese, pepperoni, ham, turkey, sausage, kielbasa), or combination of the above. The containers 130 are prepackaged and offered for sale separately, so that a consumer can pick and choose which vegetable, fruit, and/or deli food to use to assemble the food platter assembly 100.

Optionally, as shown in FIG. 1, a dipping container 180 may be used with the platter assembly 100. Preferably, the dipping container 180 is disposed over the center 112 inside the second circular ridge 120. The dipping container 180 is preferably a right circular cylinder. The dipping container 180 may contain one of different types of dipping sauces, such as a vegetable dip (regular, light, low-fat, or fat-free), a fruit dip, a mustard, or other suitable condiment. The dipping container 180 is removably replaceable on the base platter 110 and may include a groove similar to the second groove 152 to facilitate locating the dipping container 180 onto the base platter 110.

The containers 130, 130′ are shaped so that a whole number of containers 130, 130′ and specific combinations thereof may be arranged on the base platter 110 without excess space between adjacent containers 130, 130′. In the embodiment shown in FIG. 1, for example, the containers 130 are arranged as wedges similar to pieces of pie, with eight pieces making up the whole pie.

An advantage to providing the containers 130, 130′ with different foods in each container 130, 130′ is to allow consumers a selection of the different types of foods to include in their food platter assemblies 100, rather than be forced into one selection that is provided by a provider, such as a grocery store.

Preferably, the provider of the assembly 100, such as the grocery store, displays a plurality of base platters 110 on a display proximate to a plurality of prepackaged containers 130, 130′ containing different selections of foods and a plurality of dipping containers 180 containing different selections of dipping sauces. For example, each different type of food can be thought of as a subset of all of the foods available in the containers 130, 130′ and the dipping containers 180, with different foods being in different subsets. Preferably, multiple subsets are available to encourage different selections of subsets.

Preferably, the consumer selects the base platter 110 and a plurality of containers 130, 130′ from the available selection of pre-packaged containers 130, 130′, making selections from at least two of the multiple available subsets being provided. With a selection of different foods available in the containers 130, 130′, the consumer will be able to select those containers 130, 130′that the consumer anticipates will be eaten when the platter assembly 100 is assembled and set out, such as for a party.

The consumer preferably selects at least enough containers 130, 130′ to fill in around the base platter 110 without leaving spaces between adjacent containers 130, 130′. The consumer may even select more containers 130, 130′ than will fill in around the base platter 110 in order to be able to remove an empty container 130, 130′ and replace that container 130, 130′ with a full container 130, 130′ after all of the food has been removed from the empty container 130, 130′. Similarly, the consumer selects at least one dipping container 180 to place in the center 112 of the base platter 110.

After purchase of the assembly 100, the consumer places the base platter 110 on a surface, such as a table (not shown). The consumer removes the lids 160 and the seals 162, 166 from their respective containers 130, 130′ and arranges the containers 130, 130′ on the base platter 110. After use, if there is still food left within a container 130, 130′, the consumer replaces the lid 160 onto that particular container 130, 130′ and puts the container 130, 130′ away, such as in a refrigerator (not shown). The base platter 110 may be stored away for future use.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

What is claimed is:

1. A food platter assembly comprising:
a base platter sized to retain a plurality of containers disposed thereon; and
the plurality of containers, wherein each of the plurality of containers contains a prepackaged food product contained therein.

2. The food platter assembly according to claim 1, wherein the plurality of containers are identically sized.

3. The food platter assembly according to claim 1, wherein each of the plurality of containers includes:
a first wall having a first end, a second end, and a first radiused portion extending between the first end and the second end, wherein the first radiused portion includes a center point;
a second wall extending from the first end toward the center point; and
a third wall extending from the second end toward the center point.

4. The food platter assembly according to claim 3, further comprising a fourth wall connecting the second wall and the third wall, wherein the fourth wall comprises a second radiused portion including the center point.

5. The food platter assembly according to claim 1, wherein the base platter comprises an outer diameter, and wherein the outer diameter comprises a ridge extending therefrom.

6. The food platter assembly according to claim 5, wherein each of the plurality of containers comprises a corresponding groove in the first wall such that the corresponding groove engages the ridge when each of the plurality of containers is located on the base platter.

7. The food platter assembly according to claim 1, wherein the plurality of containers contain at least two different types of food.

8. The food platter assembly according to claim 1, wherein each of the plurality of containers comprises a removable and replaceable lid over an opening in each respective container.

9. The food platter assembly according to claim 8, further comprising a seal removably sealing each lid to each of the plurality of containers.

10. The food platter assembly according to claim 1, further comprising a seal removable sealing an opening in each respective container.

11. The food platter assembly according to claim 1, wherein each of the plurality of containers is interlockingly engageable with an adjacent container of the plurality of containers.

12. A method of assembling a party tray assembly comprising:
providing a base platter;
providing a selection from a plurality of containers, wherein a first subset of the plurality of containers contain different foods contained therein than a second subset of the plurality of containers;
selecting at least one of the plurality of containers from the first subset and at least one of the plurality of containers from the second subset; and
placing the at least two of the plurality of containers onto the base platter.

13. The method according to claim 12, wherein providing the selection from the plurality of containers comprises each of the plurality of containers containing prepackaged food.

14. The method according to claim 12, wherein providing the base platter comprises providing a ridge along an outer portion of the base platter and wherein providing the selection from the plurality of containers comprises providing a groove corresponding to the ridge in each of the plurality of containers.

15. A method of providing a party tray assembly comprising:
providing a base platter; and
providing a selection from a plurality of containers, wherein a first subset of the plurality of containers contain different foods contained therein than a second subset of the plurality of containers, wherein each of the plurality of containers is sized to fit onto a portion of the base platter.

16. The method according to claim 15, wherein providing the selection from the plurality of containers comprises each of the plurality of containers containing prepackaged food.

17. The method according to claim 15, wherein providing the base platter comprises providing a ridge along an outer portion of the base platter and wherein providing the selection from the plurality of containers comprises providing a groove corresponding to the ridge in each of the plurality of containers.
